(19) United States
(12) Patent Application Publication
(10) Pub. No.: US 2021/0159564 A1
(43) Pub. Date: May 27, 2021

(54) SELF-PACKAGED BATTERY

(71) Applicant: XERION ADVANCED BATTERY CORP., Kettering, OH (US)

(72) Inventors: Eliot Bethke, Champaign, IL (US); Ryan Kohlmeyer, Dayton, OH (US); Chadd Kiggins, Dayton, OH (US); Memet Ates, Kettering, OH (US); John Busbee, Beavercreek, OH (US); John Cook, Beavercreek, OH (US); Sonika Rajput, Beavercreek, OH (US)

(73) Assignee: XERION ADVANCED BATTERY CORP., Kettering, OH (US)

(21) Appl. No.: 17/094,355

(22) Filed: Nov. 10, 2020

Related U.S. Application Data
(60) Provisional application No. 62/940,102, filed on Nov. 25, 2019.

(51) Int. Cl. H01M 50/186; H01M 4/70; H01M 4/04; H01M 10/0525; H01M 50/184

(52) U.S. Cl. CPC H01M 50/186; H01M 4/70; H01M 2004/021; H01M 10/0525; H01M 50/184; H01M 4/04

(57) ABSTRACT

Batteries having current collectors that are sealed at their borders to encapsulate the active material and dispense with the need to use separate packaging, and methods of fabrication thereof.

### CROSS-REFERENCE TO RELATED APPLICATIONS

This application claims priority to, and the benefit of, U.S. provisional patent application Ser. No. 62/940,102 filed on Nov. 25, 2019, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to batteries and methods of fabrication, and more particularly to lithium ion batteries and their packaging.

### 2. Background Discussion

Advanced packaging technologies play an essential role in achieving high energy density batteries. This is especially important in microbatteries where >50% of the total mass can be comprised of packaging material and sealant that forms the hermetic seals, which in turn reduces the energy density. Microbatteries are typically formed through processes traditionally used in the semiconductor industry. As one example, active material may be sputtered onto a rigid substrate that is approximately 1 mm thick, and the battery layers are built up from there. Finally, another material (typically a polymer or another rigid substrate like a silicon wafer) is placed over the formed stack and sealed onto the aforementioned thick substrate. In this arrangement, the thick substrate, the polymer top sealing layer or second rigid substrate, and the adhesive form the “packaging”. Furthermore, tabs or through-holes need to be run outside the packaging to make an electrical connection. All these steps together represent the shortcomings of the current microbattery sealing process, which result in higher cost, and lower energy.

### SUMMARY OF THE DISCLOSURE

This disclosure generally describes a battery, and more particularly a “self-packaged” battery having current collectors that are sealed at their borders to encapsulate the active material without the need to use separate packaging.

This technology addresses the drawbacks of current microbattery packaging methods by using the current collectors as the packaging material, which obviates the need for additional packaging material to hermetically seal the microbattery. In addition to this, tabs are also eliminated because an electrical connection can be made directly to the current collectors, which eliminates potential regions that could fail and leak. The energy density is also increased by not using tabs because the tabs are inactive components that add mass and volume. Therefore, the manufacturing speed is significantly increased and the cost is reduced as a result of removing the traditional packaging step. This sealing technology is not limited to microbatteries, but can be applied to both very large cells (100's of Ah's) and very small cells (μAh). Taken together, this new technology increases the robustness and safety of the cell, increases the energy, and decreases cost.

In one embodiment, a battery according to the presented technology comprises a cathode current collector, an anode current collector, and an active material deposited on at least one of the current collectors, wherein the current collectors have borders sealed by an adhesive, and wherein the electrode stack (positive electrode, separator, electrolyte, and negative electrode) active material is encapsulated between the current collectors. This packaging approach is differentiated from current commercial sealing that uses either laminate pouch material or a cylindrical/prismatic metal “can” to hermetically encase the battery stack (anode, cathode, electrolyte and separator) because the sealing material is engineered to be electrically isolated from the cell stack. The technology described herein leverages the packaging being electronically connected to the cell stack, which enables a direct electrical connection right to the packaging.

In another embodiment, a “self-packaged” battery according to the presented technology comprises (a) a cathode current collector with a sealing border; (b) a cathode active material; (c) a separator; (d) an adhesive seal, (e) an anode active material; (f) an anode current collector with a sealing border; and (g) an electrolyte; (h) wherein the current collectors provide packaging for the active materials without requiring separate packaging.

In another embodiment, a “self-packaged” battery according to the presented technology comprises (a) a cathode current collector with a sealing border; (b) a cathode active material; (c) separator; (d) an adhesive seal; (e) an anode current collector with a sealing border; and (f) an electrolyte; (g) wherein the current collectors provide packaging for the active materials without requiring separate packaging.

In a still further embodiment, a “self-packaged” battery according to the presented technology comprises (a) a cathode current collector with a sealing border; (b) a cathode active material; (c) a separator; (d) an adhesive seal; (e) a porous or nonporous spacer; (f) an anode current collector; and (g) an electrolyte; (h) wherein the current collectors provide packaging for the active materials without requiring separate packaging.

In any of the foregoing embodiments, the electrolyte may be a liquid and the separator may be porous such that the liquid electrolyte flows into pores in the separator.

It will be appreciated that this technology addresses the drawbacks of current microbattery packaging methods by using the current collectors as the packaging material, which obviates the need for additional packaging material to hermetically seal the microbattery. In addition to this, tabs are also eliminated because an electrical connection can be made directly to the current collectors, which eliminates potential regions that could fail and leak. The energy density is also increased by not using tabs because the tabs are inactive components that add mass and volume. Therefore, the manufacturing speed is significantly increased and the cost is reduced as a result of removing the traditional packaging step. Taken together, this new technology, increases the robustness and safety of the cell, increases the energy, and decreases cost.

In any of the foregoing embodiments, a solid-state electrolyte may be used for the separator and conductive media and, therefore, a liquid electrolyte is not required.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A through FIG. 1E: Schematic diagrams of an embodiment of a battery according to the presented technology. FIG. 1A is cross-section of the layered battery structure. FIG. 1B is a top view of an cathode current carrier layer and electrode. FIG. 1C is a top view of a separator layer. FIG. 1D is an adhesive seal. FIG. 1E is a bottom view of an anode current carrier and electrode.

FIG. 2A through FIG. 2E: Schematic diagrams of a second embodiment of a battery according to the presented technology. FIG. 2A is a cross-section of the layered battery structure. FIG. 2B is a top view of a cathode current carrier layer and electrode. FIG. 2C is a top view of a separator layer. FIG. 2D is an adhesive seal. FIG. 2E is a bottom view of an anode current carrier.

FIG. 3A through FIG. 3F: Schematic diagrams of a third embodiment of a battery according to the presented technology. FIG. 3A is a cross-section of the layered battery structure. FIG. 3B is a top view of a cathode current carrier layer and electrode. FIG. 3C is a top view of a separator layer. FIG. 3D is a top view of a spacer. FIG. 3E is an adhesive seal. FIG. 3F is a bottom view of an anode current carrier.

FIG. 4A shows conventional coin cell data of LCO with and without lithium as an electrode.

FIG. 4B shows data from the same coin cell of FIG. 4A showing the Coulombic efficiency and cycle life over the interval shown.

FIG. 5: Schematic example of an assembled battery using border sealing according to an embodiment of the presented technology along with a graph showing sample performance data.

FIG. 6: Schematic depictions of slurry coated electrodes with laser removed sealing edges/cut of various dimensions/according to embodiments of the presented technology.

FIG. 7: Schematic depictions of Xerion Advanced Battery Corporation's DirectPlate™ electroplated LCO electrode with laser removed sealing edges/cut electrodes according to embodiments of the presented technology.

### DETAILED DESCRIPTION

In general terms the presented technology is a cell or battery construct that does not require separate packaging for containing the active materials. More specifically, in the battery technology presented herein, the current carriers also act as encapsulation layers for the active materials. The active material is coated (through slurry casting, electrodeposition or other method) on one or more of the current carriers inside a bare border area that is either patterned or formed by etching away active material. The bare borders are used for sealing the perimeters of the current carriers together such that the active material stack (anode, cathode, electrolyte and separator) is encapsulated within the current carriers.

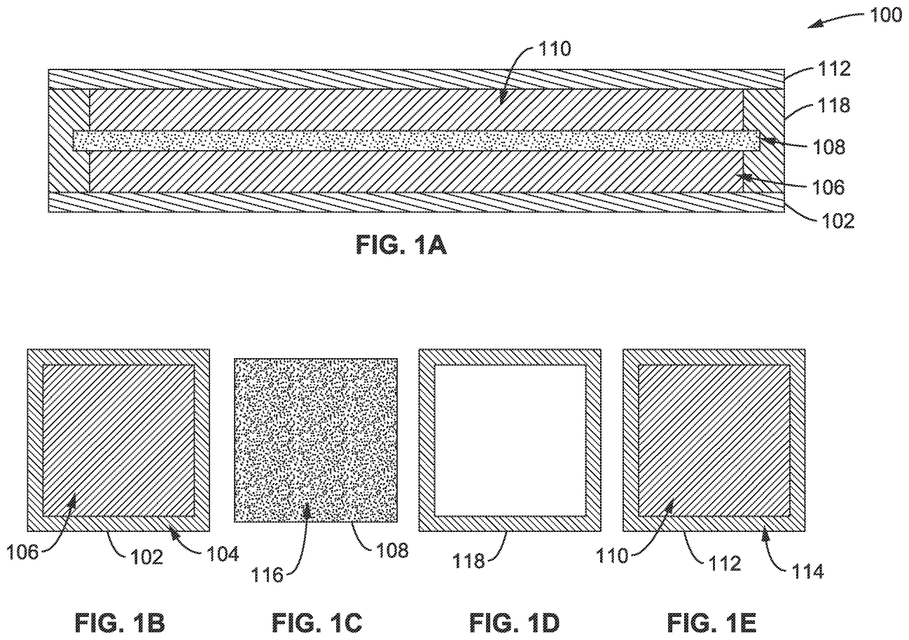

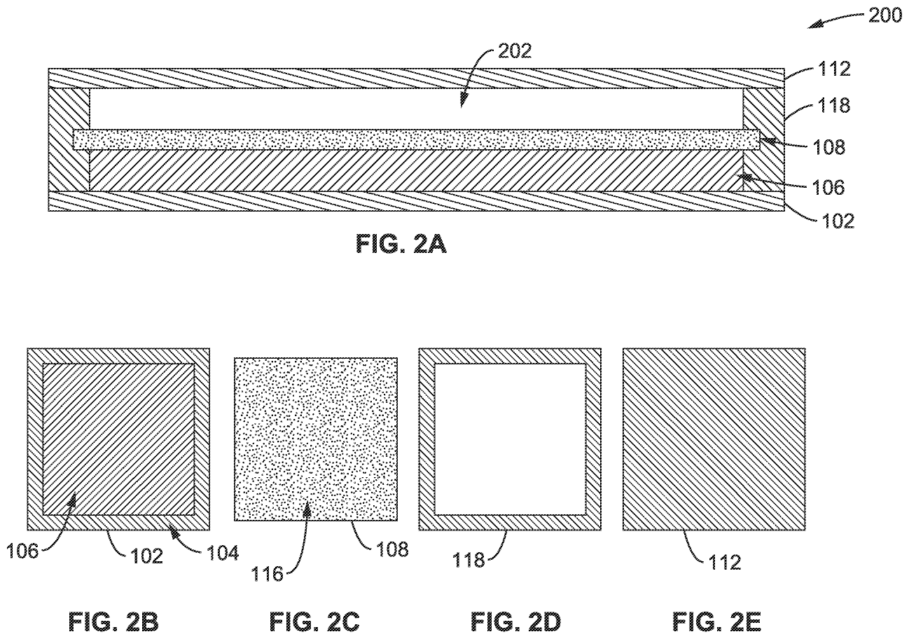

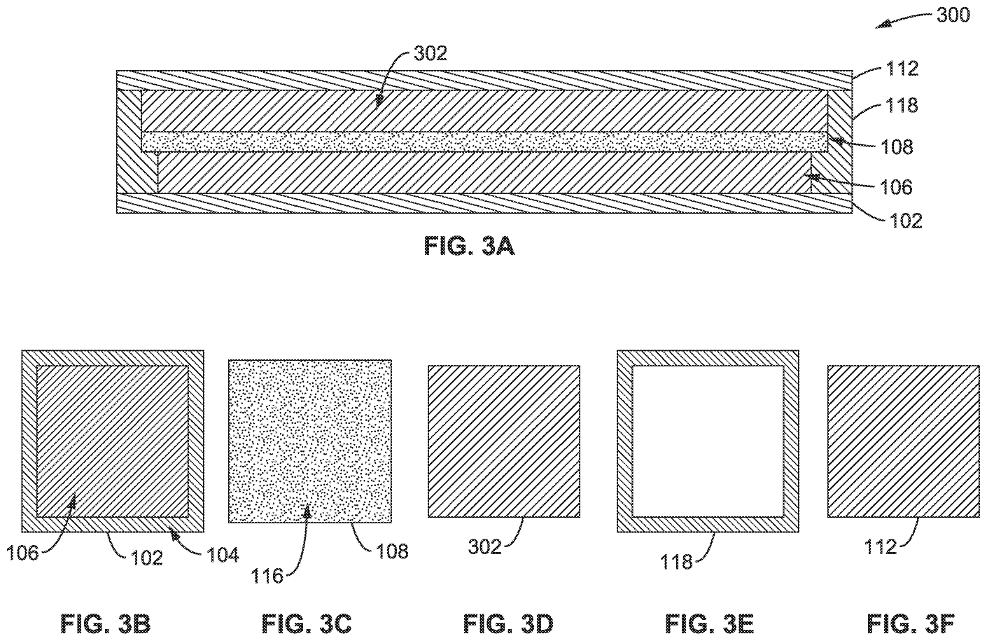

FIG. 1A through FIG. 1E, FIG. 2A through FIG. 2E, and FIG. 3A through FIG. 3F schematically illustrate embodiments of self-packaged batteries according to the presented technology. In those figures, as well as other figures in this disclosure, stippling and line patterns are used to delineate different components, areas and materials of the structures for purposes of clarity. Like stippling and patterns should not be construed to indicate the same or similar components, areas or materials, and the reader should refer to the reference numbers and their associated descriptions for such information.

Refer now to FIG. 1A through FIG. 1E which show an example of a self-packaged battery 100 according to the presented technology. In the embodiment shown, the battery comprises a cathode current collector 102 with a sealing border 104, a cathode active material 106, a separator 108, an anode active material 110, an anode current collector 112 with a sealing border 114, an electrolyte 116 in the separator 108, and a seal 118 comprising an adhesive material applied to the sealing borders to seal the perimeters of the current collectors.

FIG. 2A through FIG. 2E show another embodiment 200 of a self-packaged battery according to the presented technology. Battery 200 is similar to battery 100 shown in FIG. 1 except that there is no active material on the anode current collector. In this embodiment, an empty space 202 is present instead of active material on the anode current collector. It will also be appreciated that there is no separately defined sealing border area around the perimeter of the anode current collector in this embodiment since there is no interior active material; that is, the border can be any perimeter area of the current collector. In other respects, like reference numbers denote like components and materials in relation to the description of FIG. 1.

FIG. 3A through FIG. 3F show a further embodiment 300 of a self-packaged battery according to the presented technology. This embodiment is similar to battery 200 in that there is no active material on the anode current collector. However, instead of an empty space 202 in place of the active material, battery 300 includes a porous or nonporous spacer 302 that is used to apply a stack pressure and which holds electrolyte, thereby allowing for more uniform lithium deposition. In other like reference numbers denote like components and materials in relation to the description of FIG. 1.

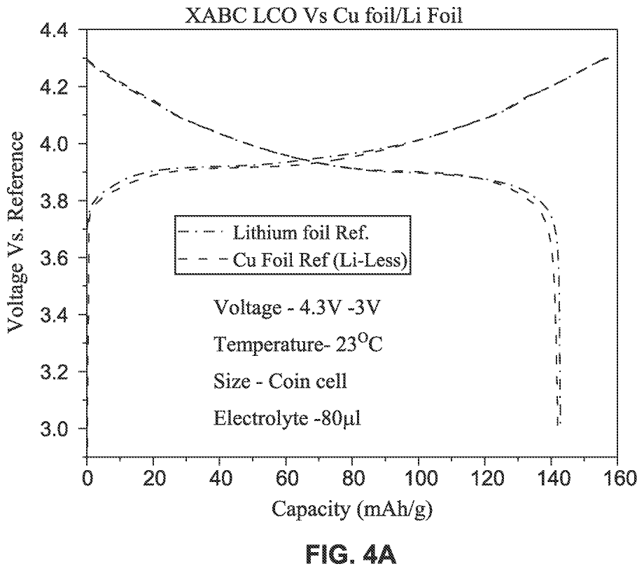

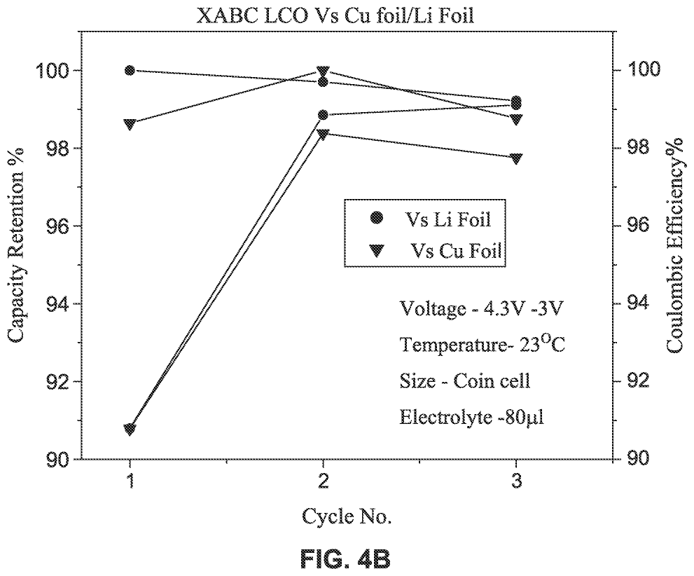

FIG. 4A and FIG. 4B illustrate functionality of the embodiments shown in FIG. 2A-E and FIG. 3A-F where an active material is not present on the anode current collector and a lithiated active material is present on the cathode current collector. The graph in FIG. 4A shows conventional coin cell data of lithium cobalt oxide (LiCoO₂ or commonly LCO) with and without lithium as an electrode (see legend). Lithium is plated on the bare anode current collector (copper here) and during discharge this lithium is then intercalated back into the cathode (LCO here) in this no lithium design. The design with lithium foil operates by lithium being plated onto the lithium foil anode and during discharge this lithium is then intercalated back into the cathode (LCO here). The graph in FIG. 4B shows data from the same coin cell showing the Coulombic efficiency and cycle life over the interval shown.

In any of the embodiments, the electrolyte may be a liquid and the separator may be porous such that the liquid electrolyte flows into pores in the separator.

In any of the embodiments, a solid-state electrolyte may be used for the separator and a liquid electrolyte is not required.

In any of the embodiments, the electrolyte may be a polymer electrolyte.

In various embodiments, the sealing border may be a bare border formed using laser ablation, electrodeposition, or masked slurry coating.

In various embodiments, the sealing border may have a width preferably ranging from about 10 μm to about 1000 μm, more preferably ranging from about 1 mm to about 10 mm, and more preferably about 1 mm. Narrower sealing borders provide higher energy density whereas wider sealing borders provide a more stable seal.

In one embodiment, the active material may be located inside the bare border.

In various embodiments, the cathode current collector may be a material selected from the group consisting of aluminum foil, aluminum, aluminum alloys, stainless steel, stainless steel alloys, gold, platinum, titanium, titanium alloys, and carbon. Other materials may be used as well.

In various embodiments, the cathode current collector may have a thickness preferably ranging from about 2 μm to about 500 μm, and more preferably about 23 μm.

In one embodiment, the cathode current collector is nonporous.

In various embodiments, the anode current collector may be a material selected from the group consisting of nickel, nickel alloys, copper, copper alloys, stainless steel, stainless steel alloys, gold, platinum, titanium, titanium alloys, and carbon. Other materials may be used as well.

In various embodiments, the anode current collector preferably has a thickness ranging from about 2 μm to about 500 μm, and more preferably about 9 μm.

In one embodiment, the anode current collector is nonporous.

In various embodiments, the cathode active material may comprise a material selected from the group consisting of Xerion's DirectPlate™ LCO, NMC, NCA, LMO, LFP, LiMn_{1.5}Ni_{0.5}O₄, LiMn₂O₃, LCO, LiCFₓ and combinations thereof. Other active materials may be used as well.

In various embodiments, the cathode active material may comprise a commercial slurry selected from the group consisting of sulfur, LCO, LiMn₂O₄, LiFePO₄, and LiNiMnCoO₂ and combinations thereof. Other active materials may be used as well.

In various embodiments, the cathode active material may have a thickness ranging from about 1 μm to about 1000 μm, and preferably ranging from about 80 μm to about 120 μm.

In various embodiments, the anode active material may comprise a material selected from the group consisting of electroplated lithium, lithium alloys, magnesium, magnesium alloys, silicon, silicon alloys, germanium, germanium alloys, tin, tin alloys and combinations thereof. Other active materials may be used as well.

In various embodiments, the anode active material may comprise a commercial slurry selected from the group consisting of commercial slurries of LTO, lithium, graphite, silicon, tin, carbon nanotubes, carbon nanofibers, Ge, and graphene and combinations thereof. Other active materials may be used as well.

In various embodiments, the anode active material may have a thickness preferably ranging from about 1 μm to about 1000 μm, and more preferably ranging from about 20 μm to about 80 μm.

In various embodiments, the cathode active material may be applied to the cathode current collector using a technique such as slurry coating or electrodeposition.

In various embodiments, the adhesive material may comprise a material selected from the group consisting of Canvera 1110 P.O.D., polyolefins, epoxies (thermally or UV-curable), Cyanoacrylate (superglue), enhanced sulphurize polymer resin (MTI tape), solventless epoxy (Hardman) (thermally or UV-curable), and Diphenylmethane diisocyanate (Gorilla glue) or combinations thereof. Other adhesive materials may be used for sealing the borders as well.

In various embodiments, the adhesive seal may be applied to the perimeter as a viscous fluid by hand or machine, or more preferably through printing.

In one embodiment, lithium may be used from the cathode alone, which decreases both the cost and the cell thickness thereby increasing the energy density. During the first charge lithium is plated on the bare anode current collector and during discharge this lithium is then intercalated into the cathode. This design has been tested at Xerion, and the first cycle Coulombic efficiency is about 90%, and without polarization at C/10 (10 hour charge or discharge).

In one embodiment, the separator may have a thickness of about 20 μm.

Examples of suitable separator materials include, but are not limited to, Celgard®2340, 2325, C500, C480, 2320, C300, C250, C200, C212, M825, M824, 2400, 2500, A273, 3400/3401, 3500/3501, 4550, 4560, 5550, etc., trilayer separators, monolayer separators, coated separators, and the like.

In various embodiments, liquid electrolyte may be a material selected from the group consisting of LiPF₆, LiBOB, LiFOB, LiBF₄, LiClO₄, LiCl, LiBr and LiTFSI dissolved in a carbonate blend (EC, DEC, DMC, EMC, PC, and combinations thereof). Other materials may be used as well.

In various embodiments, the battery size, described by the length of one edge, may range from about 1 μm to about 1 mm, about 1 mm to about 10 mm, about 10 mm to about 100 mm, and about 10 cm to about 1000 cm, but can have other sizes and form factors as well (e.g., the form factor is not limited to square).

In various embodiments, the battery capacity may range from about 1 μAh to about 40 Ah. Other capacities may be used too.

In various embodiments, a battery according the presented technology can be fabricated according to the following steps or a modification thereof depending on the whether there is active material on the anode current collector or whether the spacer is used. The first step would be to coat electrode (active) material onto the substrate being used for the current collector (e.g., electroplate, or slurry cast). A next step would be to remove active material from the perimeter of the current collector to create the sealing border, by for example, laser etching. Next, the electrodes and separator are assembled and sealant is applied to the sealing borders to form a robust seal around the entire perimeter except for a small region for electrolyte filling. The assembly is then filled with electrolyte and the filling region sealed off (if a liquid electrolyte is used instead of a solid-state electrolyte separator), and the device is complete and ready for use.

### Example 1

### Battery

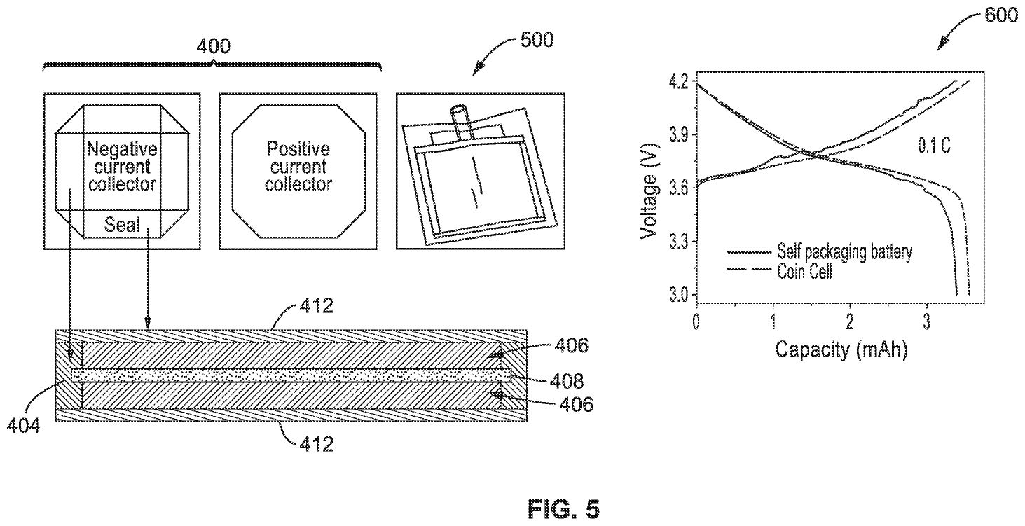

FIG. 5 is a schematic representation a battery 400 that was fabricated in a stainless steel pouch having a diameter of about 2.5 cm and assembled using the border sealing according to the presented technology. On the left is depicted a stainless steel negative current collector (not coated with active material) with a 5 mm heat seal tape perimeter border and a sulfurized polymer resin sealant applied to the border. On the right is depicted a stainless steel positive current collector on the opposite side of the battery. The sealed battery in this example comprised both lithium cobalt oxide and lithium active materials, the separator, and the electrolyte. This battery used about 12 mm NMC and about 12 mm Li foil, has an active area of about 12 mm, and has a capacity of about 3.0 mAh/cm².

FIG. 5 also schematically depicts a second battery 500 employing the same sealing technology but with some differences to show the versatility of the technology. This battery was sealed with Canvera 1110 P.O.D., and used copper as the negative current collector. Three sides were sealed, and the remaining top side left open with a filling tube to insert electrolyte. After the electrolyte is filled, the final seal is made.

The graph 600 in FIG. 5 compares galvanostatic charge and discharge data obtained at 22° C. and at a constant current of 311 μA for the battery 400 and a conventional coin cell battery. This data demonstrates that the self-packaged device operates similar to a coin cell with a standard seal.

Positioned below the battery 400 in FIG. 5 is a cross sectional schematic diagram of the battery showing the negative current collector 402, seal 404, negative active material 406 (e.g., lithium), separator 408 (e.g., Celgard), positive active material 410 (e.g., LCO or Xerion Advanced Battery Corporation's DirectPlate LCO described in U.S. Pat. No. 9,780,356), and positive current collector 412 (e.g., stainless steel, Cu, Ni).

### Example 2

### Slurry Coated Electrodes Laser Sanded/Cut Electrodes

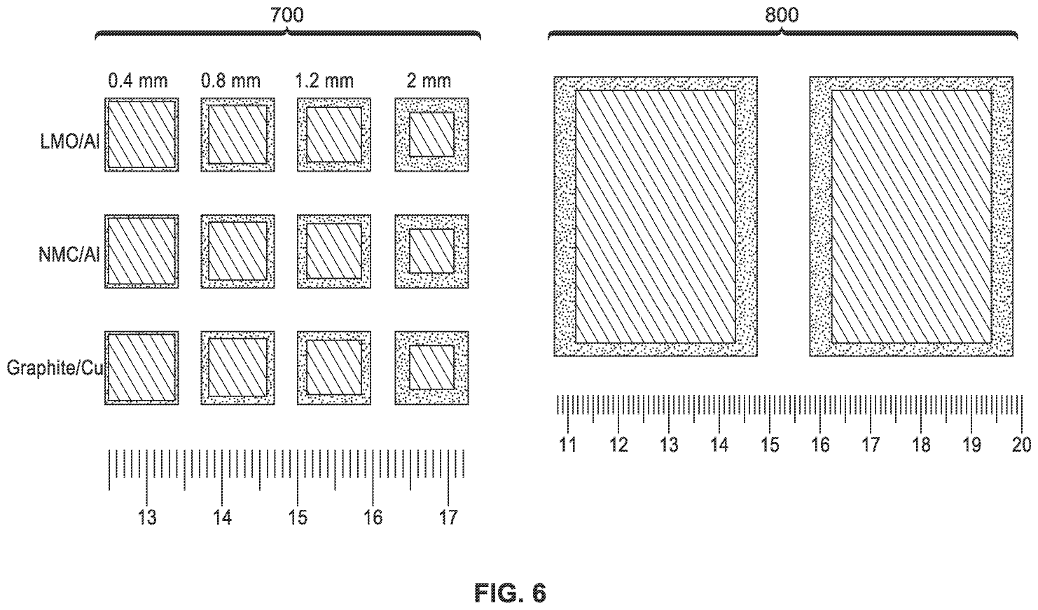

FIG. 6 shows schematic representations of various slurry coated electrodes that were fabricated from various active materials and having various sealing border widths according to embodiments of the presented technology. The left side of the figure depicts microscale (about 1 cm×1 cm) slurry coated electrodes 700 with, from left to right, laser removed perimeters of 0.4 mm, 0.8 mm, 1.2 mm and 2 mm, and from top to bottom, materials of LMO/Al, NMC/Al, and Graphite/Cu. The right side of the figure depicts macroscale (about 6 cm×4 cm) slurry coated electrodes 800 with a 3 mm laser removed perimeter, and from left to right, materials of Graphite/Cu and LMO/Al. Scales are provided to illustrate approximate sizes.

### Example 3

### Laser Sanded/Cut Electrodes

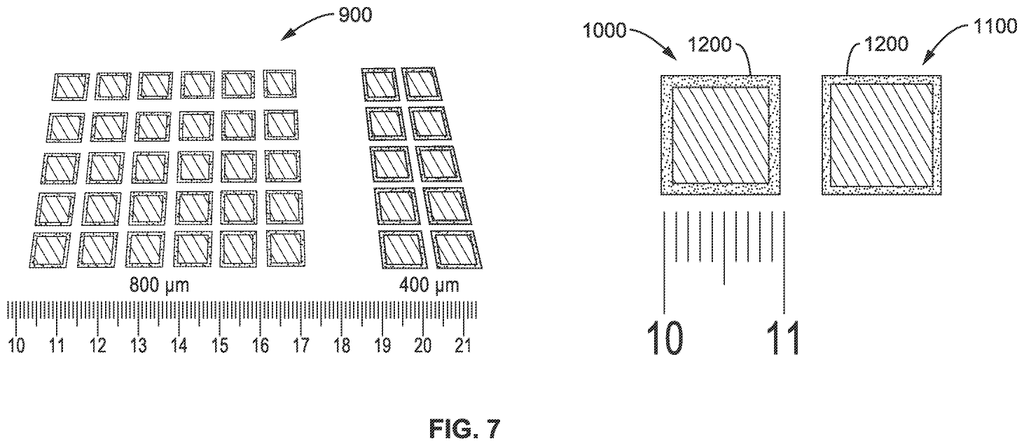

FIG. 7 schematically depicts examples of Xerion Advanced Battery Corporation's DirectPlate™ electroplated LCO electrodes with laser removed sealing edges/cut electrodes that were fabricated according to embodiments of the presented technology. The left side of the figure depicts sanded/cut electrodes 900. The right side of the figure depicts enlarged views of those electrodes and schematically depict thin 1000 and thick 1100 electrodes with laser patterned sealing borders 1200. The thin electrodes are about 3 μm in thickness while the thick electrodes are about 120 μm in thickness, which demonstrates the versatility of the laser process that exposes the sealing border. Scales are provided to illustrate approximate sizes.

### Example 4

### Sealing

A. Canvera Preparation (this material is used on the bare edges to form a seal). Note: The resultant solution is referred to as POD solution or POD coating (PolyOlefin Dispersion).

Materials:

Table 1 sets forth materials used.

Procedure:

1. Prepare in advance approximately 250 mL of a solution of 0.3% by weight DMEA in DI water. Mix under medium stirring for 10 minutes or until thoroughly mixed. Cap and set aside. This solution is referred to as basic water.

2. Prepare in advance a 30% by weight solution of primid QM-1260 in basic water. Prepare 25-50 mL total; this is not used in large quantity. Add Primid QM-1260 slowly under moderate stirring; this takes a while to dissolve completely, but it will dissolve (30 min-1 hour). Cap and set aside. This solution is referred to as Primid solution. When not in use, cap and store in 4° C. refrigerator.

3. Measure out 44.57 g Canvera POD, 40.36 g basic water, 6.73 g 1-butanol, 6.73 g 2-butoxyethanol and 1.6 g Primid solution. Add each ingredient to a sealable, glass container under moderate stirring, in the order listed in the proceeding sentence. Cap container and continue stirring until solution is well mixed. It is important to stir the solution whenever possible to ensure everything remains well mixed for coating.

4. The prepared solution can be stored in a 4° C. refrigerator for approximately two weeks, allowing solution to come up to room temp under gentle stirring before using. Past two weeks, it is suspected based on testing that the volatile solvents react or evaporate, and end up causing bubbling in the final cured product. It is best to prepare the solution immediately before use if possible. It is also important to maintain a basic (9.5-11) pH to prevent premature crosslinking.

B. Application on to the Bare Edges:

According to the manufacturer, the intended mode of application of the POD solution is through an industrial sprayer. The goal is to apply an even coating that will dry to be 6-12 μm thick. In practice, this was achieved with a micropipette for better control. The material was deposited on bare foil surrounding the active material on patterned electrodes, being careful to leave a small gap (˜0.1-0.2 mm) between the material and the active material. The POD solution will wet the metal and spread slightly. Any excess was removed by wicking from the edge of the foils with a piece of clean aluminum foil until an even coating was achieved. It was important to carry this step out quickly to prevent the coating from curing prematurely in air. POD solution that dries in air will not cure correctly, and will likely crack or suffer poor adhesion. It also takes on a white color when improperly dried before curing. If the coat is too thick, it can bubble up and ruin the coat. Alternatives would be spray depositing the POD solution from a pneumatic sprayer.

C. Curing:

Curing is performed in a gravity convection oven set to 173° C. Samples are placed carefully on alumina spacers (in this example porous spacers are used) to avoid the samples curing to the metal racks. Binder for active materials typically melts around 176-178° C. according to MTI, which is part of the reason 173° C. was chosen as a curing temp. As soon as the samples are loaded, close the door and start a timer. The oven typically dropped 10-15° C. from the loading process. Samples were left to cure for 3-3.5 min, depending on how low the temp got after loading. By 2-3 min into the curing the oven should have recovered to −170° C. The datasheet for the POD recommends a minimum cure of 170° C. for 1.5 min. Typically, by 3.5 min the temperature had recovered to 173° C., and the samples were removed and let cool in air. Copper foils seemed to cure faster (30-45 seconds less time), possibly due to their heat transfer coefficient and their being thinner than the aluminum. The coating did not appear to suffer extra time in the cure, but what was risked was the overshoot of the oven PID causing loss of adhesion of the active materials after being removed, which did happen repeatedly at 5 minutes cure time. When properly cured, the coating should appear translucent and semi-gloss.

D. Post Curing:

No post curing was recommended. Before exposing the coating to electrolyte, it is recommended the coatings undergo heated vacuum drying at 65° C. for 6-8 hours to drive off any remaining solvents or moisture, same as is recommended for porous active materials.

E. Electrolyte Interaction:

Samples were submerged in 1M LiPF6 (EC:DMC) electrolyte for 2 months. During that time, the weight loss and gain were within error of the scale (˜1.3% fluctuation). At each week for the first 4 weeks, the sample was removed, dried with kimwipes and tested for conductivity (Open circuit test) with a DMM. After 2.5 months, the coating remained visually unchanged, and no shorting was detectable through the coating with low current testing.

F. T-Peel Testing:

Samples were prepared using battery grade 20 μm aluminum foil. A single or double coat of POD solution was cast using the pipette technique described in Application. Testing samples were cut from the prepared samples after measuring the thickness and checking for consistency. Samples were cured using an impulse sealer for variable amounts of time, then set up in a homemade linear rail force measuring device. Samples were carefully clamped in aluminum screw clamps at 180° under no tension. The force gauge was zeroed, then the motor activated to pull the sample apart at a constant, slow rate. Peak force was measured at the fixed end using a DFS-50N Nextech digital force gauge. After the samples had been fully peeled apart, the final reading was recorded. Satisfactory T-peel test results were observed.

From the description herein, it will be appreciated that that the present disclosure encompasses multiple embodiments which include, but are not limited to, the following:

1. A self-packaged battery comprising current collectors and active material between the current collectors, wherein the current collectors have sealed borders that encapsulate the active material, and wherein the current collectors provide packaging for the active material without requiring separate packaging.

2. A self-packaged battery comprising: (a) a cathode current collector; (b) an anode current collector; and (c) an active material deposited on at least one of the current collectors; (d) wherein the current collectors have borders sealed by an adhesive material; and (e) wherein the active material is encapsulated between the current collectors and the current collectors provide packaging for the active materials without requiring separate packaging.

3. A self-packaged battery comprising: (a) a cathode current collector with a sealing border; (b) a cathode active material; (c) a separator; (d) an anode active material; (e) an anode current collector with a sealing border; (f) an electrolyte; and (g) an adhesive material that seals the sealing borders; (h) wherein the current collectors provide packaging for the active materials without requiring separate packaging.

4. A self-packaged battery comprising: (a) a cathode current collector with a sealing border; (b) a cathode active material; (c) a separator; (d) an anode current collector with a sealing border; (e) an electrolyte; and (f) an adhesive material that seals the sealing border; (g) wherein the current collectors provide packaging for the active materials without requiring separate packaging.

5. A self-packaged battery comprising: (a) a cathode current collector with a sealing border; (b) a cathode active material; (c) a separator; (d) a porous or nonporous spacer; (e) an anode current collector with a sealing border; (f) an electrolyte; and (g) an adhesive material that seals the sealing border; (h) wherein the current collectors provide packaging for the active materials without requiring separate packaging.

6. A method of fabricating a self-packaged battery, comprising providing the current collectors and active material of any preceding embodiment and sealing the borders of the current collectors to encapsulate the active material, wherein the current collectors provide packaging for the active material without requiring separate packaging.

7. A method of fabricating a self-packaged battery, comprising providing current collectors having borders, placing an active material between the current collectors, and sealing the borders of the current collectors to encapsulate the active material, wherein the current collectors provide packaging for the active material without requiring separate packaging.

8. The battery or method of any preceding embodiment, wherein the electrolyte comprises a liquid that flows into pores in the separator.

9. The battery or method of any preceding embodiment, wherein the separator and electrolyte comprise a solid-state electrolyte.

10. The battery or method of any preceding embodiment, wherein the electrolyte comprises a polymer electrolyte.

11. The battery or method of any preceding embodiment, wherein the sealing border comprises a bare border formed using laser ablation, electrodeposition, or masked slurry coating.

12. The battery or method of any preceding embodiment, wherein the sealing border has a width preferably ranging from about 10 μm to about 1000 μm, more preferably ranging from about 1 mm to about 10 mm, and more preferably about 1 mm.

13. The battery or method of any preceding embodiment, wherein narrower sealing borders provide higher density and wherein wider sealing borders provide a more robust seal.

14. The battery or method of any preceding embodiment, wherein the active electrode material is located inside the bare border.

15. The battery or method of any preceding embodiment, wherein the cathode current collector comprises a material selected from the group consisting of aluminum foil, aluminum, aluminum alloys, nickel, nickel alloys, copper, copper alloys, stainless steel, stainless steel alloys, gold, platinum, titanium, titanium alloys, and carbon.

16. The battery or method of any preceding embodiment, wherein the cathode current collector has a thickness preferably ranging from about 2 μm to about 500 μm, and more preferably about 23 μm.

17. The battery or method of any preceding embodiment, wherein the cathode current collector is nonporous.

18. The battery or method of any preceding embodiment, wherein the anode current collector comprises a material selected from the group consisting of aluminum foil, aluminum, aluminum alloys, nickel, nickel alloys, copper, copper alloys, stainless steel, stainless steel alloys, gold, platinum, titanium, titanium alloys, and carbon.

19. The battery or method of any preceding embodiment, wherein the anode current collector preferably has a thickness ranging from about 2 μm to about 500 μm, and more preferably about 9 μm.

20. The battery or method of any preceding embodiment, wherein the anode current collector is nonporous.

21. The battery or method of any preceding embodiment, wherein the cathode active material comprises a material selected from the group consisting of DirectPlate LCO, NMC, NCA, LMO, LFP, LiMn_{1.5}Ni_{0.5}O₄, LiMn₂O₃, LCO, LiCFₓ and combinations thereof. Other active materials may be used as well.

22. The battery or method of any preceding embodiment, wherein the cathode active material comprises a slurry selected from the group consisting of sulfur, LCO, LiMn₂O₄, LiFePO₄, and LiNiMnCoO₂.

23. The battery or method of any preceding embodiment, wherein the cathode active material has a thickness ranging from about 1 μm to about 1000 μm, and preferably ranging from about 80 μm to about 120 μm.

24. The battery or method of any preceding embodiment, wherein the anode active material comprises a material selected from the group consisting of DirectPlate LCO, NMC, NCA, LMO, LFP, LiMn_{1.5}Ni_{0.5}O₄, LiMn₂O₃, LCO, LiCFₓ and combinations thereof.

25. The battery or method of any preceding embodiment, wherein the anode active material comprises a slurry selected from the group consisting of LTO, lithium, graphite, silicon, tin, carbon nanotubes, carbon nanofibers, Ge, and graphene and combinations thereof. Other active materials may be used as well.

26. The battery or method of any preceding embodiment, wherein the anode active material has a thickness preferably ranging from about 1 μm to about 1000 μm, and more preferably ranging from about 80 μm to about 120 μm.

27. The battery or method of any preceding embodiment, wherein the cathode active material is applied to the cathode current collector using a technique such as slurry coating or electrodeposition.

28. The battery or method of any preceding embodiment, wherein the current collectors have borders sealed by an adhesive material selected from the group consisting of Canvera 1110 P.O.D., polyolefins, polyimides, epoxies (thermally or UV-curable), Cyanoacrylate (superglue), enhanced sulphurize polymer resin (MTI tape), solventless epoxy (hardman) (thermally or UV-curable), and Diphenylmethane diisocyanate (gorilla glue) or combinations thereof.

29. The battery or method of any preceding embodiment, wherein the adhesive material is applied to the borders by hand, by machine, or through printing.

30. The battery or method of any preceding embodiment, wherein lithium is used from the cathode alone and plated on the bare anode current collector during charging.

31. The battery or method of any preceding embodiment, wherein the separator has a thickness of about 20 μm.

32. The battery or method of any preceding embodiment, wherein the separator comprises a material with pores that hold the electrolyte.

33. The battery or method of any preceding embodiment, wherein the liquid electrolyte comprises a material selected from the group consisting of LiPF₆ dissolved in a carbonate blend (EC, DEC, DMC, EMC, PC, and combinations thereof).

34. The battery or method of any preceding embodiment, wherein the battery size, described by the length of one edge, may range from about 1 μm to about 1 mm, about 1 mm to about 10 mm, about 10 mm to about 100 mm, and about 10 cm to about 1000 cm, but can have other sizes and form factors as well (e.g., the form factor is not limited to square).

35. The battery or method of any preceding embodiment, wherein the battery capacity ranges from about 1 μAh to about 40 Ah.

36. The battery of any of preceding embodiment, wherein the current collectors have borders formed by laser ablation.

37. The battery or method of any preceding embodiment, wherein the adhesive material is applied to the borders by hand, by machine, or through printing.

38. The battery or method of any preceding embodiment, wherein the borders are hermetically sealed by the adhesive material.

39. The battery or method of any preceding embodiment, wherein the battery is fabricated with current collectors that are sealed at their borders to encapsulate the active material and dispense with the need to use separate packaging.

40. The battery or method of any preceding embodiment, wherein the borders have widths ranging from about 1 μm to about 10 mm.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing group of elements, indicates that at least one of these group elements is present, which includes any possible combination of these listed elements as applicable.

References in this specification referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

As used herein, the terms “approximately”, “approximate”, “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
Canvera Preparation Materials

| Chemical | Source | Total % | Notes |
|---|---|---|---|
| Canvera 1110 P.O.D. | Dow Chemical | 44.57 | 1 L Sample |
| Dimethylethanolamine | 99+%, Alpha | 0.13 | |
| (DMEA) | Aesar | | |
| Water | | 41.35 | |
| 2-Butoxyethanol | 99%, Alpha | 6.73 | |
| | Aesar | | |
| 1-butanol | 99%, Alpha | 6.73 | |
| | Aesar | | |
| Primid QM-1260 | EMS Griltech | 0.48 | Sample from |
| | | | Switzerland |

What is claimed is:

1. A self-packaged battery comprising current collectors and active material between the current collectors, wherein the current collectors have sealed borders that encapsulate the active material, and wherein the current collectors provide packaging for the active material without requiring separate packaging.

2. A self-packaged battery comprising:
(a) a cathode current collector;
(b) an anode current collector; and
(c) an active material deposited on at least one of the current collectors;
(d) wherein the current collectors have borders sealed by an adhesive material; and
(e) wherein the active material is encapsulated between the current collectors and the current collectors provide packaging for the active material without requiring separate packaging.

3. A self-packaged battery comprising:
(a) a cathode current collector with a sealing border;
(b) a cathode active material;
(c) a separator;
(d) an anode active material;
(e) an anode current collector with a sealing border;
(f) an electrolyte; and
(g) an adhesive material that seals the sealing borders;
(i) wherein the current collectors provide packaging for the active materials without requiring separate packaging.

4. A self-packaged battery comprising:
(a) a cathode current collector with a sealing border;
(b) a cathode active material;
(c) a separator;
(d) an anode current collector with a sealing border;
(e) an electrolyte; and
(f) an adhesive material that seals the sealing border;
(g) wherein the current collectors provide packaging for the active material without requiring separate packaging.

5. A self-packaged battery comprising:
(a) a cathode current collector with a sealing border;
(b) a cathode active material;
(c) a separator;
(d) a porous or nonporous spacer;
(e) an anode current collector with a sealing border;
(f) an electrolyte; and
(g) an adhesive material that seals the sealing border;
(h) wherein the current collectors provide packaging for the active material without requiring separate packaging.

6. The battery of any of claims 3 through 5, wherein the electrolyte comprises a liquid that flows into pores in the separator.

7. The battery of any of claims 3 through 5, wherein the separator and electrolyte comprise a solid-state electrolyte.

8. The battery of any of claims 1 through 5, wherein the current collectors have borders formed by laser ablation.

9. The battery of claim 8, wherein the borders have widths ranging from about 1 μm to about 10 mm.

10. The battery of any of claims 1 through 5, wherein the adhesive material is applied to the borders by hand, by machine, or through printing.

11. The battery of any of claims 1 through 5, wherein the current collectors have borders sealed by an adhesive material selected from the group consisting of Canvera 1110 P.O.D., polyolefins, epoxies (thermally or UV-curable), Cyanoacrylate (superglue), enhanced sulphurize polymer resin (MTI tape), solventless epoxy (Hardman) (thermally or UV-curable), and Diphenylmethane diisocyanate (Gorilla glue) or combinations thereof.

12. The battery of claim 11, wherein the borders are hermetically sealed by the adhesive material.

13. A method of fabricating a self-packaged battery, comprising providing the current collectors and active material of any of claims 1 through 5 and sealing the borders of the current collectors to encapsulate the active material, wherein the current collectors provide packaging for the active material without requiring separate packaging.

14. A method of fabricating a self-packaged battery, comprising providing current collectors having borders, placing an active material between the current collectors, and sealing the borders of the current collectors to encapsulate the active material, wherein the current collectors provide packaging for the active material without requiring separate packaging.
